(19) United States
(12) Patent Application Publication
(10) Pub. No.: US 2019/0073843 A1
(43) Pub. Date: Mar. 7, 2019

(54) Forward single origin physical access verification apparatus, system, and method of operation

(71) Applicant: Steven Mark Bryant, Sterling, VA (US)

(72) Inventor: Steven Mark Bryant, Sterling, VA (US)

(21) Appl. No.: 16/172,809

(22) Filed: Oct. 28, 2018

Related U.S. Application Data
(63) Continuation-in-part of application No. 15/390,507, filed on Dec. 25, 2016.

(51) Int. Cl. G07C 9/00; H04L 9/32; H04W 12/08; H04W 12/06

(52) U.S. Cl. CPC G07C 9/00039; G07C 9/00023; G07C 9/00309; H04L 9/3228; H04L 63/20; H04W 12/08; H04W 12/06; G07C 2009/00769; G07C 2009/00246; H04L 9/3297

(57) ABSTRACT

A wireless apparatus controls physical access through a portal by forward verification of a single origin code submitted by a mobile application device. A system forward verifies a single physical access control code upon each successful physical access request. The apparatus sets a flag that triggers an action when a single origin code is received out of sequence. The controller receives a plurality of physical access requests from a plurality of mobile application devices. The controller determines for each mobile application device a sequence of access requests comprising at least a first access request and a second access request. Upon authenticating the first access request, the controller writes into storage a forward verification code specific to an immediately subsequent second access request from the same app device. Upon receiving a successor, the controller performs an authentication process by matching the stored forward verification code associated with the predecessor.

### CROSS-REFERENCE TO RELATED APPLICATIONS

The present application is a Continuation-in-Part of pending application Ser. No. 15/390,507 “Forward one-time-use physical access verification apparatus, system, and method of operation” filed Dec. 25, 2016 which is incorporated in its entirety by reference and benefits from its priority date.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### Technical Field

The disclosure relates to physical access control over portals.

### Description of the Related Art

What is known is that physical access can be enabled by presentation of a credential wirelessly but there is a risk that the signals may be recorded and replayed or that the sending device (or sending device data), may have been duplicated.

What is known is that stored access control codes may be stolen, or maliciously reproduced. As is known, conventional One Time Use codes are often generated at two different nodes-an OTP server, and on the user computer.

What is needed is a way to control a physical access portal upon determination that a counterfeit, clone, or duplicate of a physical access control device is attempting an intrusion or has already intruded.

### SUMMARY OF THE INVENTION

A physical access control system checks a sequence of access requests and determines when indicia are unusually presented out of order or reiterated.

A portal controller apparatus receives a plurality of physical access requests that includes at a minimum the users' access credential (access requests) from a plurality of mobile application devices. Because mobility is desired with the least amount of friction, a wireless coupling is utilized. Bluetooth, RFID, Wi-Fi, infrared, optical, and cellular communication channels are exemplary but non-limiting embodiments of wireless links.

The controller determines for each mobile application device (app device) a sequence of access requests which at minimum has at least a first access request and a second access request.

Upon authenticating the first access request (predecessor), the controller writes into non-transitory storage a single origin verification code specific to an immediately subsequent second access request (successor) from the same app device.

Upon receiving a successor, the controller performs an authentication process by matching the stored single origin verification code associated with the predecessor.

On the condition the authentication process passes, a newer single origin verification code is written into non-transitory storage specific to yet another immediately subsequent successor.

The wireless apparatus controls physical access through a portal by forward verification of single origin codes submitted by a mobile application device. The system forward verifies a single physical access control code upon each successful physical access request.

The apparatus sets a flag that triggers an action when a single origin code is received out of sequence. The controller receives a plurality of physical access requests from a plurality of mobile application devices.

The controller determines for each mobile application device a sequence of access requests comprising at least a first access request and a second access request.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The foregoing and other objects, aspects, features, and advantages of the disclosure will become more apparent and better understood by referring to the following description taken in conjunction with the accompanying drawings, in which:

FIGS. 1-2 are block diagrams of the system and components of apparatus embodiments;

FIGS. 3-5 are flow charts of method embodiments; and

FIG. 6 is a block diagram of a processor suitable for performing a method embodiment of the invention.

### DETAILED DESCRIPTION OF THE INVENTION

An apparatus controls physical access by actuating portals. Wireless devices present credentials and other indicia that are reconciled by a cloud server. The indicia are checked for continuity in a chain. Each successful access adds another level of credibility which is deprecated when the indicia seems out of sequence or reiterated.

### Embodiments

In one embodiment of the invention, a timestamp included in a first physical access request (predecessor) is used to verify a subsequent second physical access request. The timestamp may be transformed e.g. by masking to describe a range of time. To be accepted, the subsequent second physical access request (successor) must include the transformed timestamp of the predecessor.

On the condition the authentication process fails, the controller sets a flag of questionable chain of control associated with the app device.

In an embodiment, each newer single origin verification code is synthesized by the app device and transmitted in both a predecessor and successor request.

In an embodiment, each newer single origin verification code is a transformation of a timestamp read from the system clock of the app device.

In an embodiment, each newer single origin verification code is synthesized as transformation of the predecessor and transmitted only in the successor.

In an embodiment, each newer single origin verification code is a transformation of the result of authentication of the predecessor request.

In an embodiment, a flag of questionable chain of control causes an access control policy to be performed at the portal actuator.

In an embodiment, a range of time related to the last successful physical access request is transformed into a forward verification code. In an embodiment, the difference in time between a request and the most recent successful physical access request by that sender is transformed into a forward verification code. In an embodiment, a mask of least significant bits provides a range of time relating a request and the most recently successful physical access request by that sender is transformed into a forward verification code.

In an embodiment, a masked timestamp of the most recent successful physical access control request is transformed into a forward verification code.

The physical access controller apparatus enables a portal actuator upon verification of said successor access request only on the condition that a verification code in the successor is accepted. In an embodiment, the verification code is provided in the payload of the predecessor. In an embodiment, the verification code is derived from a seed provided in the payload of the predecessor. In an embodiment, the verification code is a transformation of the metadata associated with the successful submission of the predecessor. The transformation process may include hashing. The transformation process may include hashing a masked string of metadata to allow a range. The transformation process may include hashing a masked timestamp of the acknowledgement of the predecessor access request.

In an embodiment, the delta time between the predecessor and successor timestamps is a seed for a verification code.

A visualization of the history of verification codes would be a chain of single links. If a link is received that attaches onto other than the latest link, the system denies access and resets the verification process.

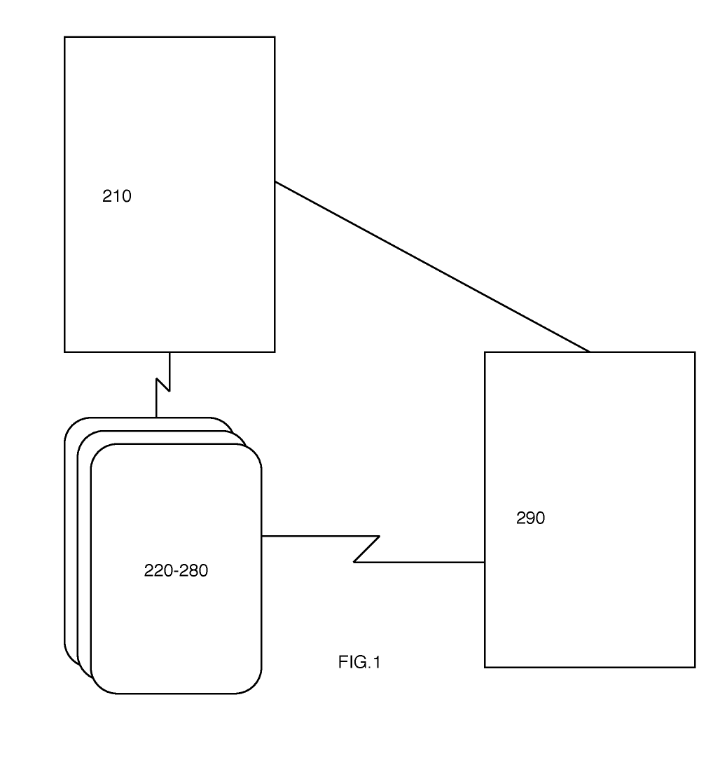

Referring now to the figures, as shown in FIG. 1, a cloud server 210 is communicatively coupled to at least one mobile application device 220-280 and further coupled to a physical access controller apparatus 290 at some point in time but not necessary communicating at the time of the point of entry attempt.

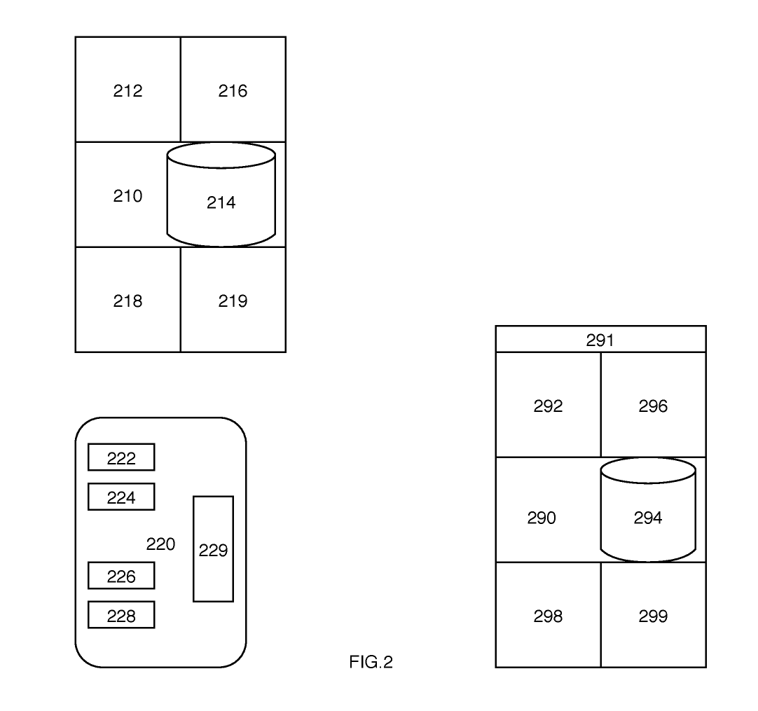

As shown in FIG. 2, the cloud server 210 includes a non-transitory store of instructions 212; a non-transitory store of digital signatures, credentials, and identities 214; a communication controller to mobile application devices 216; a communication channel to all physical access controllers 218; and a processor 219.

Each mobile application device 220 (app device) includes a non-transitory store of instructions 222; a non-transitory store of physical access request meta data 224; a wireless portal channel transceiver 226; a wireless communication channel to the cloud server 228; and a processor 229.

A physical access controller 290 apparatus (acc controller) includes a non-transitory store of instructions 292; a non-transitory store of verification codes 294; a wireless portal beacon and receiver 296; a communication channel to the cloud server 298; a processor 299, and an actual control output to control the access of a portal (e.g. the door) 291.

The method of operation of the cloud server is to distribute 310 a version controlled application (smart app) and indicia of credentials and authentication to the acc controller and the at least one app device. In an embodiment, a smart app could also be pre-installed on the app device. In an embodiment, a smart app is installed over the air from another software distribution point of origin (e.g. Apple™'s App Store).

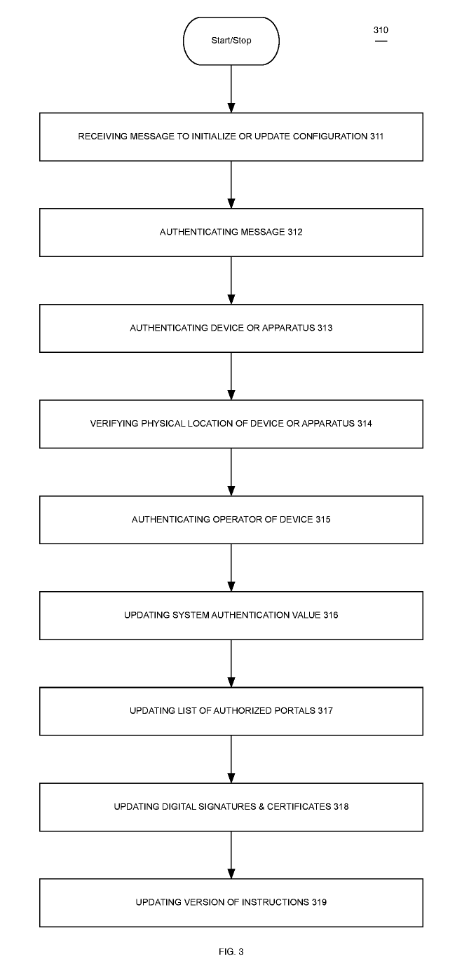

Referring to FIG. 3, the method of operation at a cloud server includes: receiving a message causing initialization/update of one or more app devices 311; authenticating the message originates from a trusted source 312; authenticating the device or apparatus to be served 313; verifying physical location of device or apparatus 314; authenticating the operator of the device 315; updating a system authentication value 316; updating a list of authorized portals 317; updating certificates and digital signatures 318; and updating version of instructions 319.

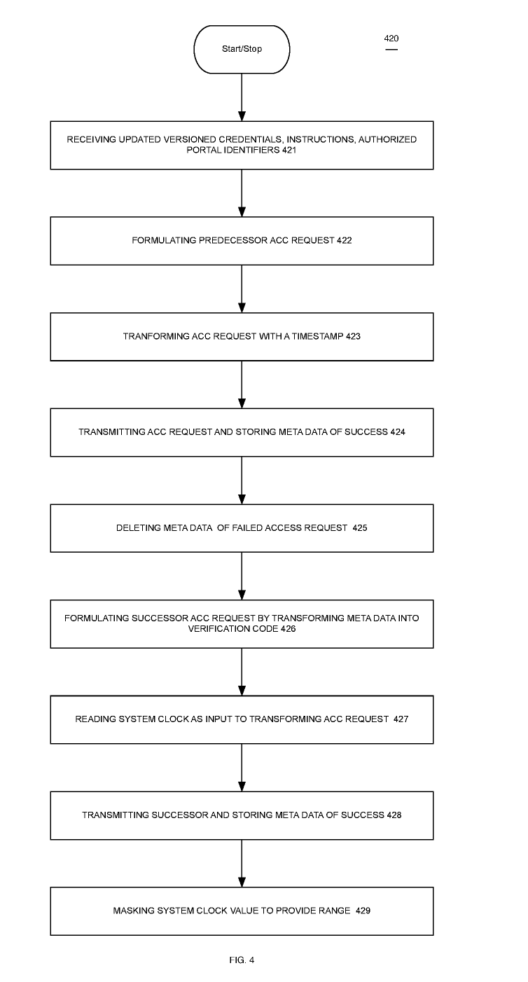

The method of operation 420 shown in FIG. 4, of a mobile application device includes: formulating 422 a first physical access request (predecessor) in response to a first signal from a first suitable wireless transceiver associated with a portal controller; transmitting 424 the predecessor and storing meta data of its receipt and acceptance into a non-transitory store; formulating 426 a second physical access request (successor) by transforming the meta data of the most recent receipt and acceptance of said predecessor into a verification code; and transmitting 428 the successor and storing meta data of its receipt and acceptance into the non-transitory store.

The method 420 further includes: transforming 423 a physical access request with a timestamp; and deleting 425 meta data records on the condition of failure in receipt or acceptance of any access request.

The method 420 further includes: reading 427 the device system clock as an input to transforming the access request; and masking 429 the device system clock value to provide a range of time.

The method of 420 further includes: receiving 421 an updated set of versioned authentication credentials, instructions, and authorized access portals.

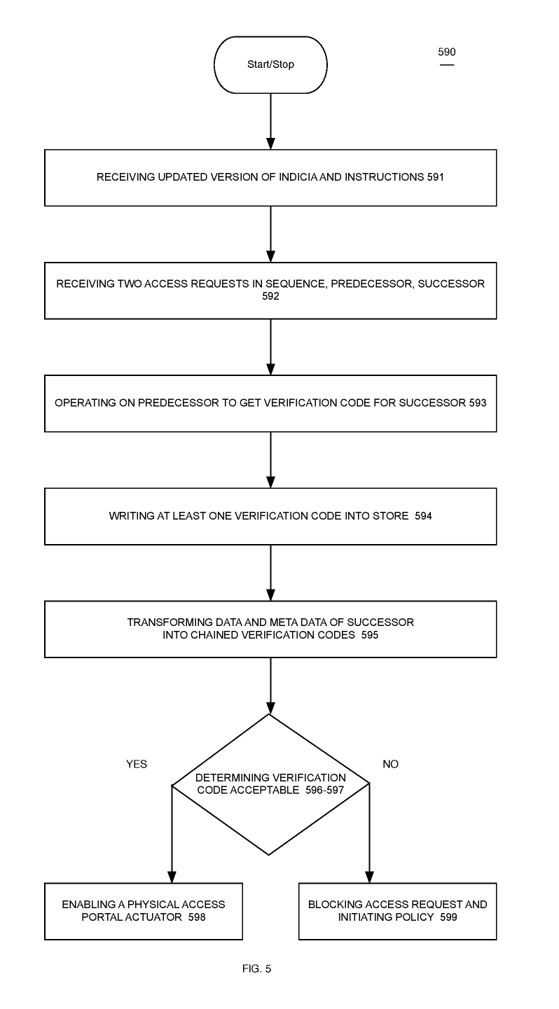

Referring to FIG. 5, the method of operation 590 of a physical access controller apparatus includes: receiving 592 at least two physical access requests (access requests) in sequence from a mobile application device wherein said two access requests are a predecessor and a successor; writing 594 at least one verification code into non-transitory store; determining 596 when a verification code associated with a successor access request is acceptable; and enabling 598 a physical access portal actuator.

The method 590 further includes determining 593 a verification code for the successor by operating on the data and meta data of the predecessor; and transforming 595 the data and meta data of the successor into a pair of chained verification codes.

The method 590 further includes: determining 597 when a verification code presented by a successor access request is unacceptable; and blocking 599 an access request and initiating a policy at the cloud server.

The method 590 further includes upon initiation, distributing an update version 591 of a smart app to at least one mobile application device and one access controller.

In another embodiment, the distinguishing aspect of the single origin code is that it is “new” and not “reused”. In this version—the controller merely stores the last used single origin code. The next access must include this last used code (validated), and a new code (stored for next access).

One aspect of the invention is a mobile application device (app device) for physical access that has: a wireless transceiver; a processor and a system clock; a non-transitory store configured with authentication certificates; a physical access application; and a non-transitory store for at least two single origin verification codes.

In an embodiment, the app device also has a non-transitory store for a system authentication value (SAV), a credential, a user ID, and executable code for hashing and transacting requests; and a circuit to transform indicia into a physical access control request.

In an embodiment the app device also has a circuit to synthesize a forward single origin verification code from a timestamp of its system clock.

In an embodiment, the app device synthesizes a forward single origin verification code pseudo-randomly.

In an embodiment the app device also has a circuit to synthesize a forward single origin verification code upon a successful physical access control request.

Another aspect of the invention is a system that has: a plurality of mobile application devices (app devices); a physical access controller (access controller) communicatively coupled to said devices; and a cloud security service server; wherein said access controller includes a non-transitory store of sequential access codes associated with each user id and credentials verified by the cloud security service server; a transceiver to receive and acknowledge physical access requests; a circuit to operate a portal actuator; and a non-transitory store of security policies.

In an embodiment, each access controller receives an updated single origin code for each app device from any other access controller. In an embodiment, each access controller recognizes only single origin codes derived from its own span of portals or individually for each portal.

In an embodiment, the system also has: a circuit to verify a physical access request with a stored forward verification code.

In an embodiment, the system also has: a circuit to perform a security policy on the condition the verification of a physical access request fails.

In an embodiment, the system also has: a circuit to cause app devices and access controllers to advance a system authentication value.

In an embodiment, the system also has: a circuit to extract and store a forward verification code from a most recently successful physical access request.

In an embodiment, the system also has: a circuit to determine a forward verification code for a user upon a most recently successful physical access request.

Another aspect of the invention is a method for control of a physical access portal comprising the processes: at a controller, receiving a plurality of physical access requests (access requests) from a plurality of mobile application devices; at the controller, determining for each mobile application device (app device) a sequence of access requests comprising at least a first access request and a second access request; at the controller, upon authenticating the first access request (predecessor), writing into non-transitory storage a single origin verification code specific to an immediately subsequent second access request (successor) from the same app device; and at the controller, upon receiving a successor, performing an authentication process by matching the stored single origin verification code associated with the predecessor.

In an embodiment, the method also has: on the condition the authentication process passes, writing a newer single origin verification code into non-transitory storage specific to yet another immediately subsequent successor.

In an embodiment, the method also has: on the condition the authentication process fails, setting a flag of questionable chain of control associated with the app device.

In an embodiment, each newer single origin verification code is synthesized by the app device and transmitted in both a predecessor and successor request.

In an embodiment, each newer single origin verification code is a transformation of a timestamp read from the system clock of the app device.

In an embodiment, each newer single origin verification code is synthesized as transformation of the predecessor and transmitted only in the successor.

In an embodiment, each newer single origin verification code is a transformation of the result of authentication of the predecessor request.

In an embodiment, a flag of questionable chain of control causes an access control policy to be performed at the portal actuator wherein, an access control policy includes at least one of an access denial to a request from a user, or a device; an iteration of system authentication value; a version update; a reauthentication process at a mobile application device; and transmission of a notification to an access control system administrator.

In an embodiment, the app device transmits a first forward verification code from the app device that is determined by a first approximate elapsed time from a first access request to a second access request measured at the app device and the portal controller compares the first forward verification code with a second forward verification code read from non-transitory storage that was previously received as a component of the most recently successful access request.

In an embodiment, the app device transmits a first forward verification code from the app device that is determined by a first approximate elapsed time from a first access request to a second access request measured at the app device and the portal controller compares the first forward verification code with a second forward verification code that is determined by a second approximate elapsed time from the first access request to the second access request measured at the portal controller.

In another embodiment of the invention, the app device and the portal controller each determine a verification code for a second physical access request based on the masked timestamp of the first physical access request. The verification code for the second physical access request is only transmitted once. The masking supports a range of precision or offset between the clock of the app device and the portal controller.

### An Exemplary Suitable Operating Environment: Computing Device

As is known, circuits disclosed above may be embodied by programmable logic, field programmable gate arrays, mask programmable gate arrays, standard cells, and computing devices limited by methods stored as instructions in non-transitory media.

Generally a computing devices 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device.

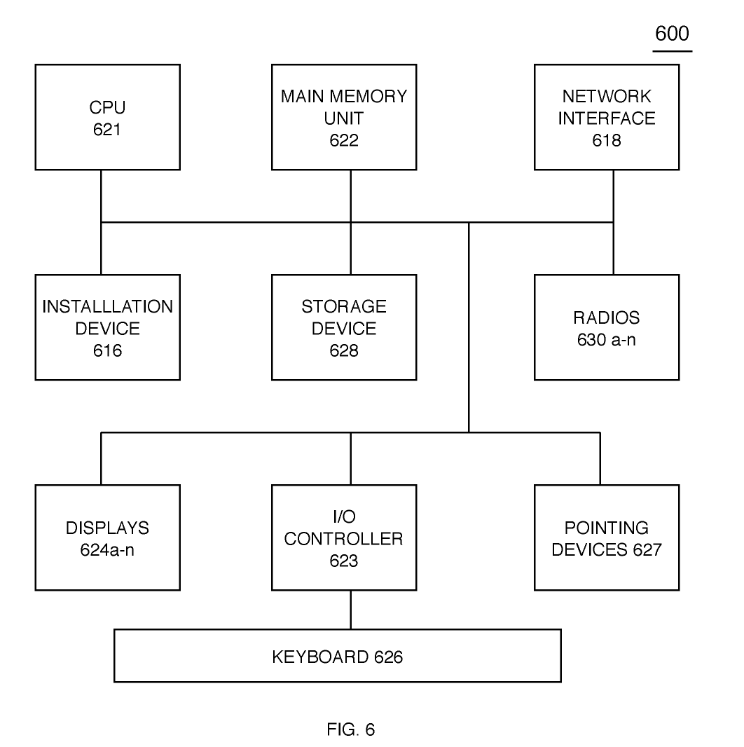

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 618 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; or Alphabet of Mountain View Calif. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

It should be understood that the systems described above may provide multiple ones of any or each of those components and these components may be provided on either a standalone machine or, in some embodiments, on multiple machines in a distributed system. The phrases in one embodiment, in another embodiment, and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

### CONCLUSION

The present invention is easily distinguished from conventional wireless apparatus physical access control systems by forward verification of single origin codes submitted by a mobile application device. The claimed invention forward verifies a single physical access control code upon each successful physical access request. The apparatus sets a flag that triggers an action when a single origin code is received out of sequence. The controller receives a plurality of physical access requests from a plurality of mobile application devices. The controller determines for each mobile application device a sequence of access requests comprising at least a first access request and a second access request. Upon authenticating the first access request, the controller writes into storage a forward verification code specific to an immediately subsequent second access request from the same app device. Upon receiving a successor, the controller performs an authentication process by matching the stored forward verification code associated with the predecessor.

Unlike conventional systems, the authentication flows in only one direction. Unlike conventional systems, the invention does not depend on secret information passed back from each portal to the mobile app device. Unlike conventional rolling codes, the forward verification determines a new code based on a successful access request. Unlike conventional systems, a range of time is supported for forward verification.

### Spirit and Scope of the Appended Claims

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Having described certain embodiments of methods and systems for restricting physical access, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A mobile application device (app device) for physical access comprises:
a wireless transceiver; a processor and a system clock;
a non-transitory store configured with authentication certificates;
a physical access application; and
a non-transitory store for at least two single origin verification codes.

2. The apparatus of claim 1 further comprising:
a non-transitory store for a system authentication value (SAV), a credential, a user ID, and executable code for hashing and transacting requests; and
a circuit to transform indicia into a physical access control request.

3. The apparatus of claim 1 further comprising:
a circuit to synthesize a forward single origin verification code from a timestamp of its system clock, and a mask of least significant bits to provide a valid range of time.

4. The apparatus of claim 1 further comprising:
a circuit to synthesize a forward single origin verification code upon a successful physical access control request.

5. A system comprises:
a plurality of mobile application devices (app devices);
a physical access controller (access controller) communicatively coupled to said devices; and
a cloud security service server; wherein said access controller comprises: a non-transitory store of sequential access codes associated with each user id and credentials verified by the cloud security service server; a transceiver to receive and acknowledge physical access requests; a circuit to operate a portal actuator; and a non-transitory store of security policies.

6. The system of claim 5 further comprising:
a circuit to verify a physical access request with a stored forward verification code.

7. The system of claim 5 further comprising:
a circuit to perform a security policy on the condition the verification of a physical access request fails.

8. The system of claim 5 further comprising:
a circuit to cause app devices and access controllers to advance a system authentication value.

9. The system of claim 5 further comprising:
a circuit to extract and store a forward verification code from a most recently successful physical access request.

10. The system of claim 5 further comprising:
a circuit to determine a forward verification code for a user upon a most recently successful physical access request.
